(19) United States
(12) Patent Application Publication
(10) Pub. No.: US 2008/0319778 A1
(43) Pub. Date: Dec. 25, 2008

(54) Neighborhood bartering in a geo-spatial network

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/821,392

(22) Filed: Jun. 22, 2007

(51) Int. Cl. G06Q 10/00

(52) U.S. Cl. 705/1

(57) ABSTRACT

A method, apparatus, and system of neighborhood bartering in a geo-spatial network are disclosed. In one embodiment, a method includes providing a plurality of user profiles, each user profile to include an associated specific geographic location, associating a first user with a first user profile, providing a plurality of item profiles, each item profile associated with a user profile, selecting an item profile from the plurality of item profiles, and generating an item transaction, between the first user profile and a second user profile associated with the selected item profile, based on at least one of the specific geographic location associated with the first user profile and the specific geographic location associated with the second user profile.

### FIELD OF TECHNOLOGY

This disclosure relates generally to the technical fields of communications and, in one example embodiment, to a method, apparatus, and system of neighborhood bartering in a geo-spatial network.

### BACKGROUND

Persons sometimes acquire and/or offer items (e.g., goods and/or services) via channels other than traditional retail transactions. For example, an offeree (e.g., a seller, a donor, etc.) may have a yard sale. The offeree may auction goods on auction websites. The offeree may post advertisements on community bulletin boards seeking and/or offering services such as childcare and/or tutoring.

These channels of exchange may present issues, however. Yard sale announcements such as signs posted around the neighborhood may cause clutter. Advertisements in local newspapers may not reach a potential market necessary to sell items. Conversely, offerors (e.g., a buyer, a donee, etc.) may not be able to determine from the announcements if the items advertised are actually available. Offerors may need to personally visit multiple locations before finding, if at all, the items sought.

Auction websites may not enable the offeree to receive the price and/or trade-for items they seek. Further, the offeror may not be able to inspect the items to ensure they meet the description and quality the buyer requires. Instead, the offeror may rely on photos and/or provided descriptions. Additionally, both parties may expend effort and funds to package, ship, and receive the items.

### SUMMARY

A method, apparatus and system of neighborhood bartering in a geo-spatial network are disclosed. In one aspect, a method includes providing a plurality of user profiles, each user profile to include an associated specific geographic location, associating a first user with a first user profile, providing a plurality of item profiles, each item profile associated with a user profile, selecting an item profile from the plurality of item profiles, and generating an item transaction, between the first user profile and a second user profile associated with the selected item profile, based on the specific geographic location associated with the first user profile and/or the specific geographic location associated with the second user profile.

The method may further include generating an item transaction display representing the item transaction as a marker in a three-dimensional map view, simultaneously representing other user profiles adjacent to the marker, and placing the marker in a geographic location associated with the second user profile. The item transaction may include a monetary donation transaction. The monetary donation transaction may further include forming a giving group including members, each member associated with a user profile, and generating monetary donations associated with the giving group.

Moreover, the method of monetary donation transaction may include establishing a monetary donation campaign including a monetary donation target, accumulating monetary donations associated with the monetary donation campaign, calculating a total of accumulated monetary donations, comparing the total of accumulated monetary donations to the monetary donation target, and determining an amount of monetary donations to be collected based on the comparison of the total of accumulated monetary donations and the monetary donation target. The item transaction may also include a service needs transaction. The service needs transaction may further include generating a list of service needs, and locating a service matching a service need of the list of service needs. In addition, the item transaction may include a goods donation transaction. The goods donation transaction may further include selecting a donor group, and offering goods to the donor group. The goods donation transaction may also include scheduling a pickup of the goods offered to the donor group. Moreover, the item transaction may include a search for items transaction and an exchange goods and services transaction. The exchange goods and services transaction may further include a classified advertisements transaction.

In another aspect, a system includes a geographic community environment, a community network module of the geographic community environment, the community network module to include user profiles, each user profile to include an associated specific geographic location, a map module to include map data of the specific geographic locations of each user profile, an item module to include item profiles, each item profile associated with a user profile, a selection module to select an item profile, and a transaction module to generate an item transaction associated with the specific geographic location of the user profile associated with the selected item profile.

The system may further include a display module to display information associated with the item transaction. In addition, the system may include a webpage module to generate a webpage associated with the item transaction. The system may also include a wiki profile module to generate, with the webpage, at least one wiki profile associated with the webpage. The system may further include an append module to generate, with the wiki profile, content associated with the wiki profile.

Moreover, the system may include a monetary donation module to generate a monetary donation transaction. The system may also include a service needs module to generate a service needs transaction. The system may include a goods donation module to generate a goods donation transaction and a search for items module to generate a search for items transaction. The system may further include an exchange goods and services module to generate an exchange goods and services transaction. In addition, the system may include a classified advertisements module to generate classified advertisements.

In yet another aspect, a geographic community environment includes a first instruction set to enable a community network, to include a user database to include user profiles, each user profile to include an associated geographic location, and an item database to include item profiles, each item profiles associated with a user profile, the community network associated with map data, in which the community network is associated with specific geographic locations identifiable in the map data, a second instruction set integrated with the first instruction set to select an item profile, and a third instruction set integrated with the first instruction set and the second instruction set to generate an item transaction between a first user profile and a second user profile associated with the selected item profile.

Furthermore, the geographic community environment may include a fourth instruction set integrated with the first instruction set and the second instruction set and the third instruction set to generate an item transaction display to represent the item transaction as a marker in a three-dimensional map view and to simultaneously represent other user profiles adjacent to the marker and to place the marker in the geographic location associated with the second user profile associated with the selected item profile.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a geographic community environment communicating with users through a network, according to one embodiment.

FIG. 2 is an exploded view of the community network module of FIG. 1, according to one embodiment.

FIG. 3 is an exploded view of the additional modules of FIG. 1, according to one embodiment.

FIG. 4 is a user interface view of an item transaction display, according to one embodiment.

FIG. 5 is a user interface view of a monetary transaction in the geographic community environment, according to one embodiment.

FIG. 6 is a user interface view of activities in a monetary donation group in the geographic community environment, according to one embodiment.

FIG. 7 is a user interface view of a goods donation transaction, according to one embodiment.

FIG. 8 is an exemplary view of a donation slip, according to one embodiment.

FIG. 9 is a user interface view of a service needs transaction, according to one embodiment.

FIG. 10 is a user interface view of a search for items transaction, according to one embodiment.

FIG. 11 is a user interface view of an exchange goods and services transaction, according to one embodiment.

FIG. 12 is a user interface view of a classified advertisements transaction, according to one embodiment.

FIG. 13 is a table view displaying details of an item transaction in the geographic community environment, according to one embodiment.

FIG. 14 is a diagrammatic system view of a data processing system in which any of the embodiments disclosed herein may be performed, according to one embodiment.

FIG. 15 is a process flow of generating the item transaction between a first user profile and a second user profile, based on a specific geographic location, according to one embodiment.

Other features of the present embodiments will be apparent from the accompanying drawings and from the detailed description that follows.

### DETAILED DESCRIPTION

A method, system and apparatus of neighborhood bartering in a geo-spatial network are disclosed. In the following description, for the purposes of explanation, numerous specific details are set forth in order to provide a thorough understanding of the various embodiments. It will be evident, however, to one skilled in the art that the various embodiments may be practiced without these specific details.

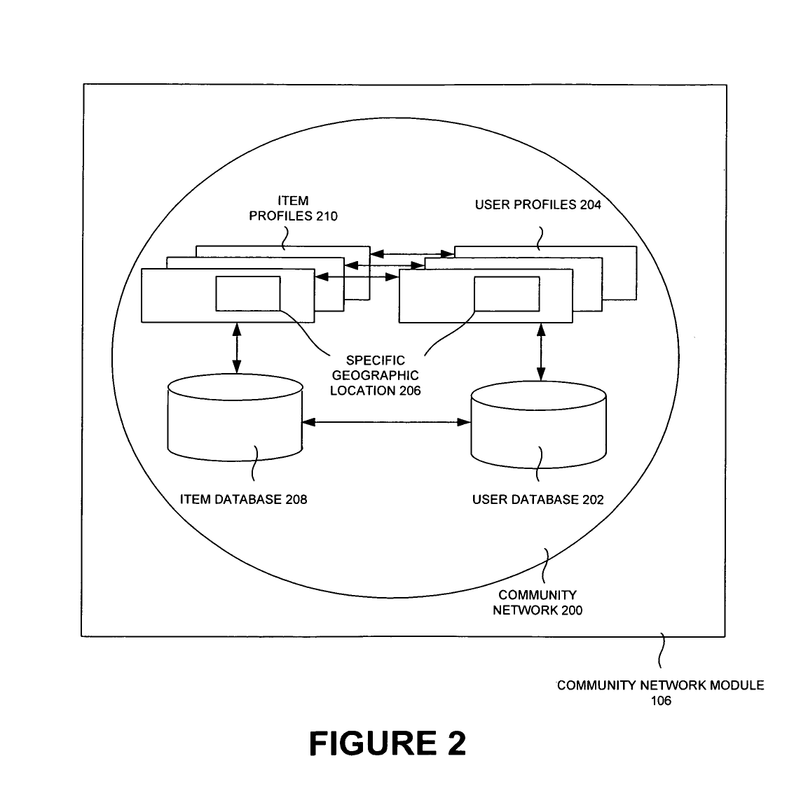

In one embodiment, a method, includes providing a plurality of user profiles (e.g., the user profiles 204 of FIG. 2), each user profile 204 to include an associated specific geographic location (e.g., the specific geographic location 206 of FIG. 2), associating a first user 102 with a first user profile 204, providing a plurality of item profiles (e.g., the item profiles 210 of FIG. 2), each item profile 210 associated with a user profile 204, selecting an item profile 210 from the plurality of item profiles 210 and generating an item transaction, between the first user profile 204 and a second user profile 204 associated with the selected item profile 210, based on the specific geographic location 206 associated with the first user profile 204 and/or the specific geographic location 206 associated with the second user profile 204.

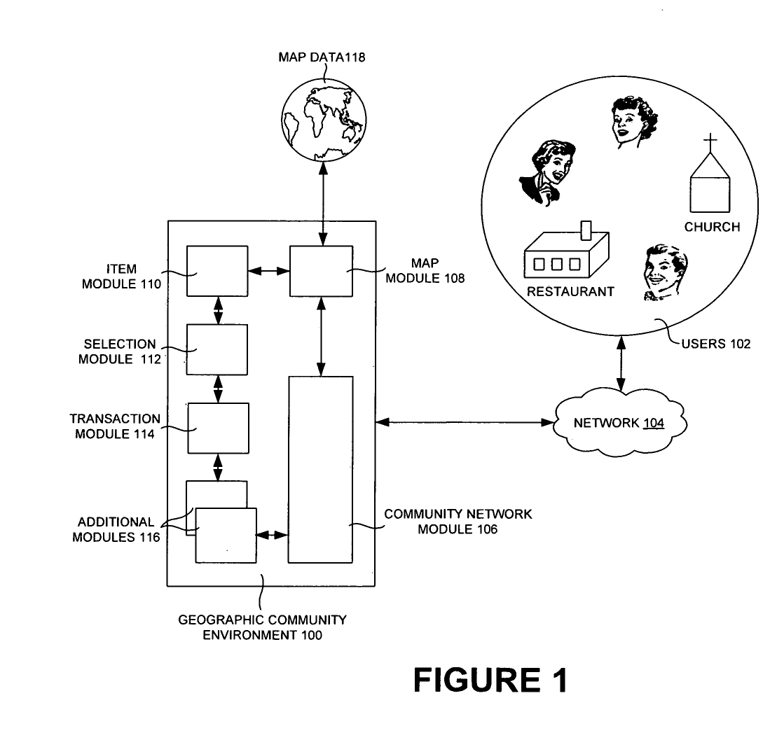

In another embodiment, a system includes a geographic community environment (e.g., the geographic community environment 100 of FIG. 1), a community network module (e.g., the community network module 106 of FIG. 1) of the geographic community environment 100, the community network module 106 to include user profiles 204, each user profile 204 to include an associated specific geographic location 206, a map module (e.g., the map module 108 of FIG. 1) to include map data (e.g., the map data 118 of FIG. 1) of the specific geographic location 206 of each user profile 204, an item module (e.g., the item module 110 of FIG. 1) to include item profiles (e.g., the item profiles 210 of FIG. 2), each item profile 210 associated with a user profile 204, a selection module (e.g., the selection module 112 of FIG. 1) to select an item profile 210, and a transaction module (e.g., the transaction module 114 of FIG. 1) to generate an item transaction associated with the specific geographic location 206 of the user profile 204 associated with the selected item profile 210.

In yet another embodiment, a geographic community environment (e.g., the geographic community environment 100 of FIG. 1) includes a first instruction set to enable a community network (e.g., the community network 200 of FIG. 2), to include a user database (e.g., the user database 202 of FIG. 2) to include user profiles (e.g., the user profiles 204 of FIG. 2), each user profile 204 to include an associated geographic location, and an item database (e.g., the item database 208 of FIG. 2) to include item profiles (e.g., the item profiles 210 of FIG. 2), each item profile 210 associated with a user profile 204, the community network 200 associated with map data (e.g., the map data 118 of FIG. 1), in which the community network 200 is associated with specific geographic locations 206 identifiable in the map data 118, a second instruction set integrated with the first instruction set to select an item profile 210 and a third instruction set integrated with the first instruction set and the second instruction set to generate an item transaction between a first user profile 204 and a second user profile 204 associated with the selected item profile 210.

FIG. 1 is a system view of a geographic community environment 100 communicating with users 102 through a network 104, according to one embodiment. Particularly, FIG. 1 illustrates the geographic community environment 100, the users 102, the network 104, a community network module 106, a map module 108, an item module 110, a selection module 112, a transaction module 114, additional modules 116 and a map data 118, according to one embodiment.

The geographic community environment 100 may enable the users 102 associated with user profiles (e.g., the user profiles 204 of FIG. 2) in a specific geographic location (e.g., the specific geographic location 206 of FIG. 2) to interact with each other through the network 104. The users 102 may be entities (e.g., a person, a church, a business, etc.) associated with the user profiles 204 involved in an item transaction in the geographic community environment 100. The network 104 may facilitate communication between the users 102 and the geographic community environment 100. The community network module 106 may enable the item transaction between the users 102 based on the specific geographic location 206 of the users 102 in the geographic community environment 100.

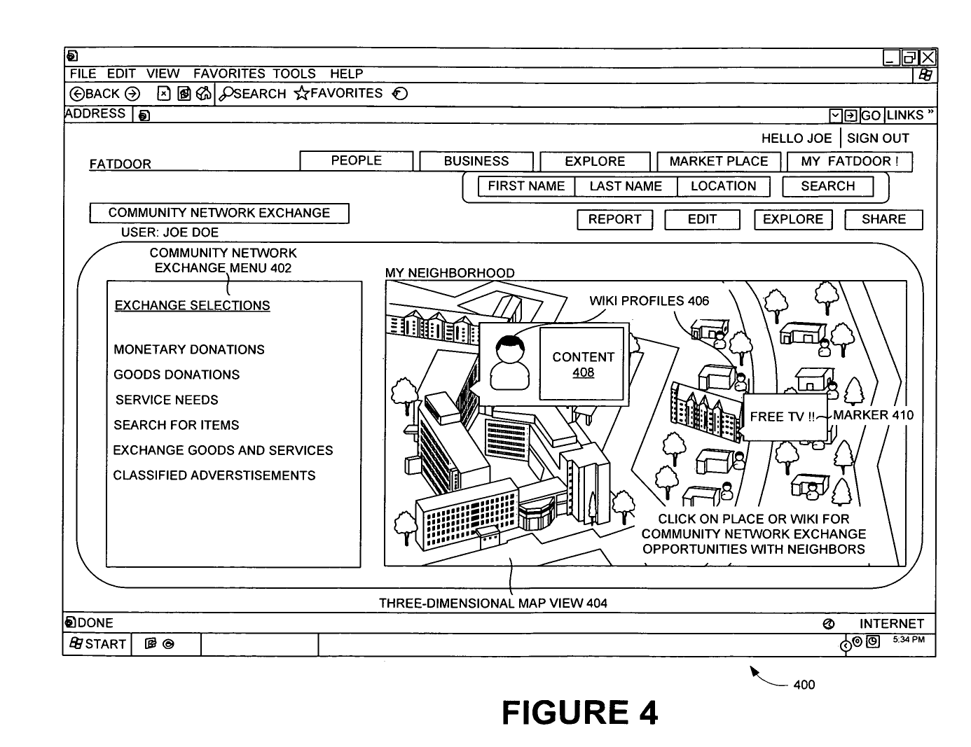

The map module 108 may generate a three-dimensional map view (e.g., the three-dimensional map view 404 of FIG. 4) which displays markers and other user profiles 204 associated with the specific geographic location 206. The item module 110 may generate item profiles (e.g., the item profiles 210 of FIG. 2) associated with the user profiles 204 in the geographic community environment 100. The selection module 112 may enable the users 102 of the geographic community environment 100 to select an item profile 210 for item transaction based on the specific geographic location 206. The transaction module 114 may generate the item transaction (e.g., a monetary donation transaction, a service needs transaction, a goods donation transaction, a search for items transaction, an exchange goods and services transaction, etc.), between a first user profile 204 and a second user profile 204 associated with a selected item profile 210 in the specific geographic location 206.

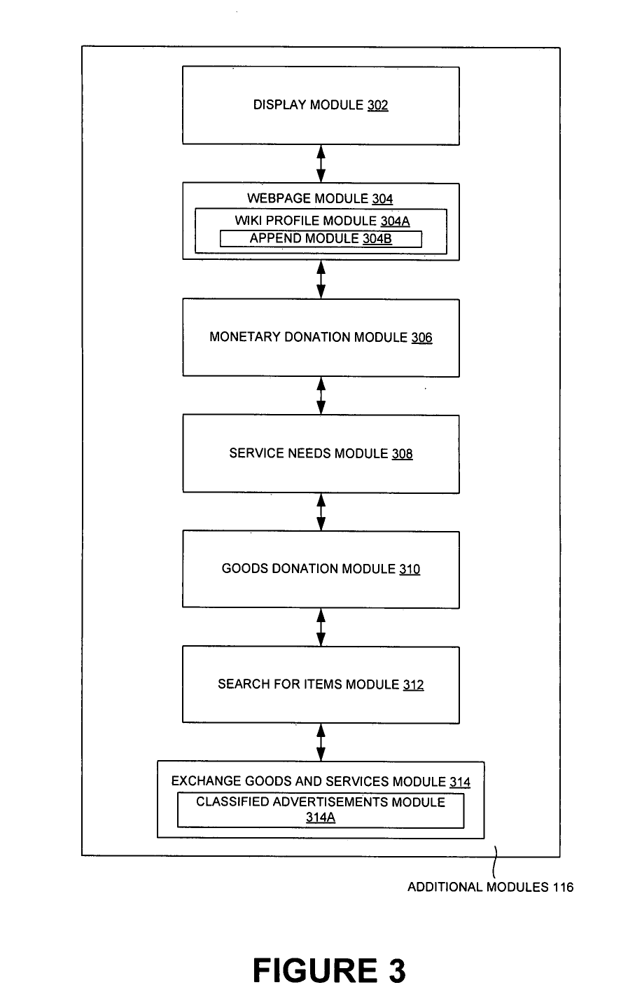

The additional modules 116 may include other modules (e.g., the display module 302, the webpage module 304, the monetary donation module 306, the service needs module 308, the goods donation module 310, the search for items module 312 and the exchange goods and services module 314 of FIG. 3) associated with the geographic community environment 100. The map data 118 may be a location data, an address data, etc. associated with the users 102 involved in the item transaction based on the specific geographic location 206.

In the example embodiment illustrated in FIG. 1, the geographic community environment 100 communicates with the users 102 through the network 104. The geographic community environment 100 consists of the community network module 106, the map module 108, the item module 110, the selection module 112, the transaction module 114 and the additional modules 116, which communicate with each other. The map module 108 also processes (e.g., generates, communicates, tracks, analyzes, stores, etc.) the map data 118.

A first user 102 may be associated with the first user profile 204. The item profile 210 may be selected from the plurality of item profiles 210. The item transaction (e.g., the monetary donation transaction, the goods donation transaction, the service needs transaction, the search for items transaction and/or the exchange goods and services transaction, etc.) may be generated between the first user profile 204 and the second user profile 204 associated with the selected item profile 210, based on the specific geographic location 206 associated with the first user profile 204 and/or the specific geographic location 206 associated with the second user profile 204.

The community network module 106 of the geographic community environment 100 may include the user profiles 204, each user profile 204 to include the associated specific geographic location 206. The map module 108 may include the map data 118 of the specific geographic location 206 of each user profile 204. The item module 110 may include the item profiles 210, each item profile 210 associated with a user profile 204. The selection module 112 may select an item profile 210. The transaction module 114 may generate the item transaction associated with the specific geographic location 206 of the user profile 204 associated with the selected item profile 210.

FIG. 2 is an exploded view of the community network module 106 of FIG. 1, according to one embodiment. Particularly, FIG. 2 illustrates a community network 200, a user database 202, user profiles 204, a specific geographic location 206, an item database 208, and item profiles 210, according to one embodiment.

The community network 200 may enable networking between the users 102 involved in the item transaction through the community network module 106 in the geographic community environment 100. The user database 202 may contain location data and/or address data associated with the user profiles 204 involved in the item transaction in the geographic community environment 100. The user profiles 204 may be profiles generated from the user database 202 associated with the users 102 involved in the item transaction based on the specific geographic location 206. The specific geographic location 206 may be a particular area in the geographic community environment 100 where the item transaction occurs between the user profiles 204.

The item database 208 may contain the item profiles 210 associated with the user profiles 204 involved in the item transaction in the geographic community environment 100. The item profiles 210 may be profiles generated from the item database 208 that are associated with the user profiles 204 involved in the item transaction.

In the example embodiment illustrated in FIG. 2, the community network module 106 includes the community network 200 with the user database 202 and the item database 208. The user profiles 204 generated from the user database 202 may be associated with the item profiles 210 generated from the item database 208 in the specific geographic location 206.

The plurality of user profiles 204 may be provided, each user profile 204 to include the associated specific geographic location 206. A plurality of item profiles 210 may be provided, each item profile 210 associated with the user profile 204. A first instruction set may enable the community network 200, to include the user database 202 to include user profiles 204, each user profile 204 to include the associated specific geographic location 206, and the item database 208 to include item profiles 210, each item profile 210 associated with the user profile 204, the community network 200 associated with the map data 118, in which the community network 200 is associated with specific geographic locations 206 identifiable in the map data 118.

A second instruction set may be integrated with the first instruction set to select an item profile 210. A third instruction set may be integrated with the first instruction set and the second instruction set to generate the item transaction between the first user profile 204 of the user profiles 204 and the second user profile 204 associated with the selected item profile 210.

FIG. 3 is an exploded view of the additional modules 116 of FIG. 1, according to one embodiment. Particularly, FIG. 3 illustrates a display module 302, a webpage module 304, a wiki profile module 304A, an append module 304B, a monetary donation module 306, a service needs module 308, a goods donation module 310, a search for items module 312, an exchange goods and services module 314 and a classified advertisements module 314A, according to one embodiment.

The display module 302 may display markers representing information associated with the item transaction in the three-dimensional map view 404. The webpage module 304 may generate a webpage to display the information associated with the item transaction in the geographic community environment 100. The wiki profile module 304A may generate a wiki profile (e.g., the wiki profiles 406 of FIG. 4) associated with the users 102 that is displayed simultaneously with the markers on the three-dimensional map view 404. The append module 304B may generate a content to add and/or modify the wiki profile 406 associated with the webpage. The monetary donation module 306 may generate financial and/or economic transactions among the users 102 of the geographic community environment 100.

The service needs module 308 may generate services (e.g., a social service) based on a list of needs of the users 102 of the geographic community environment 100. The goods donation module 310 may generate a good and/or a commodity related transaction among the users 102 of the geographic community environment 100. The search for items module 312 may enable the users 102 of the geographic community environment 100 to search the item profiles 210 associated with the user profiles 204 to generate the item transaction. The exchange goods and services module 314 may generate exchange of goods and/or services in the geographic community environment 100. The classified advertisements module 314A may generate classified advertisements of goods and/or services that are available for exchange transaction in the specific geographic location 206.

In the example embodiment as illustrated in FIG. 3, the additional modules 116 consist of the display module 302, the webpage module 304, the wiki profile module 304A, the append module 304B, the monetary donation module 306, the service needs module 308, the goods donation module 310, the search for items module 312, the exchange goods and services module 314 and the classified advertisements module 314A, communicating with each other.

The display module 302 may display information associated with the item transaction. The webpage module 304 may generate the webpage associated with the item transaction. The wiki profile module 304A may generate with the webpage, at least one wiki profile 406 associated with the webpage. The append module 304B may generate (e.g., with the wiki profile 406) content associated with the wiki profile 406. The monetary donation module 306 may generate the monetary donation transaction.

The service needs module 308 may generate the service needs transaction. The goods donation module 310 may generate the goods donation transaction. The search for items module 312 may generate the search for items transaction. The exchange goods and services module 314 may generate the exchange goods and services transaction (e.g., includes a classified advertisements transaction). The classified advertisements module 314A may generate classified advertisements.

FIG. 4 is a user interface view 400 of an item transaction display, according to one embodiment. Particularly, FIG. 4 illustrates a community network exchange menu 402, a three-dimensional map view 404, wiki profiles 406, a content 408, a marker 410, according to one embodiment.

The community network exchange menu 402 may display various exchange transactions (e.g., monetary exchange, service exchange, goods exchange, etc.) associated with the item transaction in the geographic community environment 100. The three-dimensional map view 404 may enable the users 102 involved in the item transaction to visualize their neighborhood to find opportunities for service exchange (e.g., bartering of services). The wiki profiles 406 may be a profile associated with a user 102 of the geographic community environment 100. The content 408 may be address data, location data, etc. associated with the wiki profiles 406 that are modified by other users 102 in the geographic community environment 100 until a particular wiki profile 406 is claimed by a particular user 102. The marker 410 may be used to represent the item transaction in the three-dimensional map view 404 which is placed adjacent to other user profiles 204 in the map.

In the example embodiment illustrated in FIG. 4, the user interface view 400 displays various service exchange (e.g., neighborhood services bartering) options available for the users 102 of the geographic community environment 100 to transact with each other. The community network exchange menu 402 shows monetary donations, goods donations, service needs, search for items, exchange goods and services, and classified advertisements. The wiki profiles 406 may enable the users 102 to visualize various community network exchange opportunities in the neighborhood in the three-dimensional map view 404.

The item transaction display 400 may be generated representing the item transaction as the marker in the three-dimensional map view 404. Other user profiles 204 may be simultaneously represented adjacent to the marker. The marker may be placed in the specific geographic location 206 associated with the second user profile 204. A fourth instruction set may be integrated with the first instruction set, the second instruction set and the third instruction set to generate the item transaction display 400 to represent the item transaction as the marker in the three-dimensional map view 404 and to simultaneously represent the other user profiles 204 adjacent to the marker and to place the marker in the specific geographic location 206 associated with the second user profile 204 associated with the selected item profile 210.

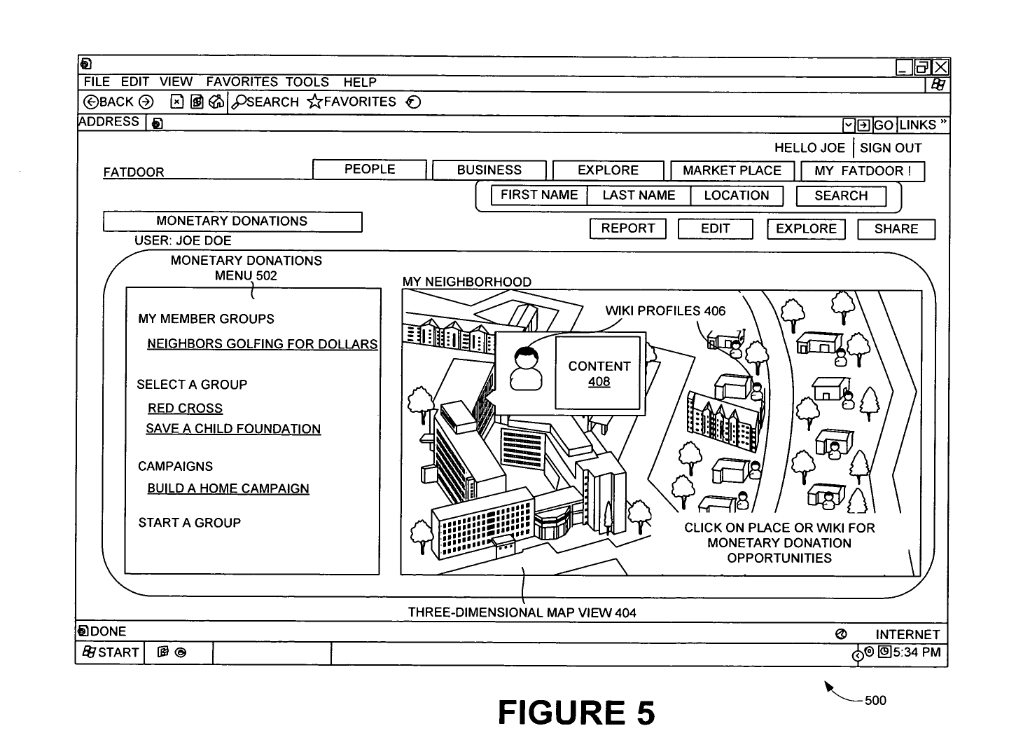

FIG. 5 is a user interface view 500 of a monetary donation transaction in the geographic community environment 100, according to one embodiment. Particularly, FIG. 5 illustrates the three-dimensional map view 404, the wiki profiles 406, the content 408 and a monetary donations menu 502, according to one embodiment.

The monetary donations menu 502 may display various giving groups formed during the monetary donations transaction to generate the monetary donations associated with the giving group.

In the example embodiment illustrated in FIG. 5, the user interface view 500 displays a giving group named “neighbors golfing for dollars” formed for the monetary donation transaction. The users 102 of the geographic community environment 100 may select required monetary groups and may also start a new group for the monetary donation transaction in the geographic community environment 100. The wiki profiles 406 may display monetary donation opportunities in the neighborhood in the three-dimensional map view 404.

The giving group (e.g., neighbors golfing for dollars) may be formed, including members, each member associated with a user profile 204 (e.g., using the additional modules 116 of FIG. 1). The monetary donations associated with the giving group may be generated (e.g., by the monetary donation module 306 of FIG. 3).

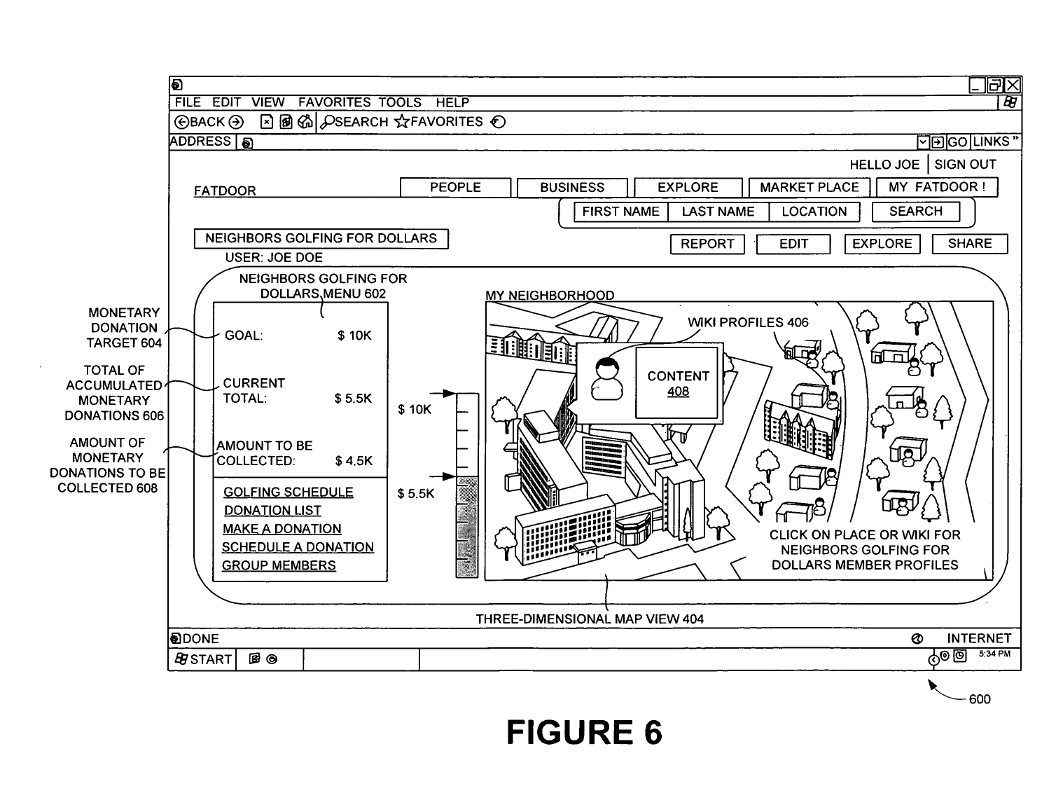

FIG. 6 is a user interface view 600 of activities in a monetary donation group in the geographic community environment 100, according to one embodiment. Particularly, FIG. 6 illustrates the three-dimensional map view 404, the wiki profiles 406, the content 408, a neighbors golfing for dollars menu 602, a monetary donation target 604, a total of accumulated monetary donations 606, an amount of monetary donations to be collected 608, according to one embodiment.

The neighbors golfing for dollars menu 602 may show members, donation lists, scheduling of donation and other activities associated with the neighbors golfing for dollars giving group formed by the users 102 associated with the user profiles 204 in the geographic community environment 100. The monetary donation target 604 may indicate a target (e.g., cash, money and/or funds) the particular giving group has to accumulate to the monetary donations.

The total of accumulated monetary donations 606 may display current monetary fund collected by the members of the neighbors golfing for dollars giving group. The amount of monetary donations to be collected 608 may display the balance amount to be collected by the members of the giving group based on a comparison of the total of accumulated monetary donations 606 and the monetary donation target 604.

In the example embodiment as illustrated in FIG. 6, the user interface view 600 displays the various monetary activities of the neighbors golfing for dollars giving group formed in the geographic community environment 100 by the members (e.g., the users associated with the user profiles) to generate the monetary donations associated with the item transaction. The users 102 of the geographic community environment 100 may also view the wiki profiles 406 of the members of the neighboring golfing for dollars giving group in the three-dimensional map view 404.

A monetary donation campaign including the monetary donation target 604 may be established. The monetary donations associated with the monetary donation campaign may be accumulated. The total of accumulated monetary donations 606 may be calculated and/or compared to the monetary donation target. The amount of monetary donations to be collected 608 may be determined based on the comparison of the total of accumulated monetary donations 606 and the monetary donation target 604.

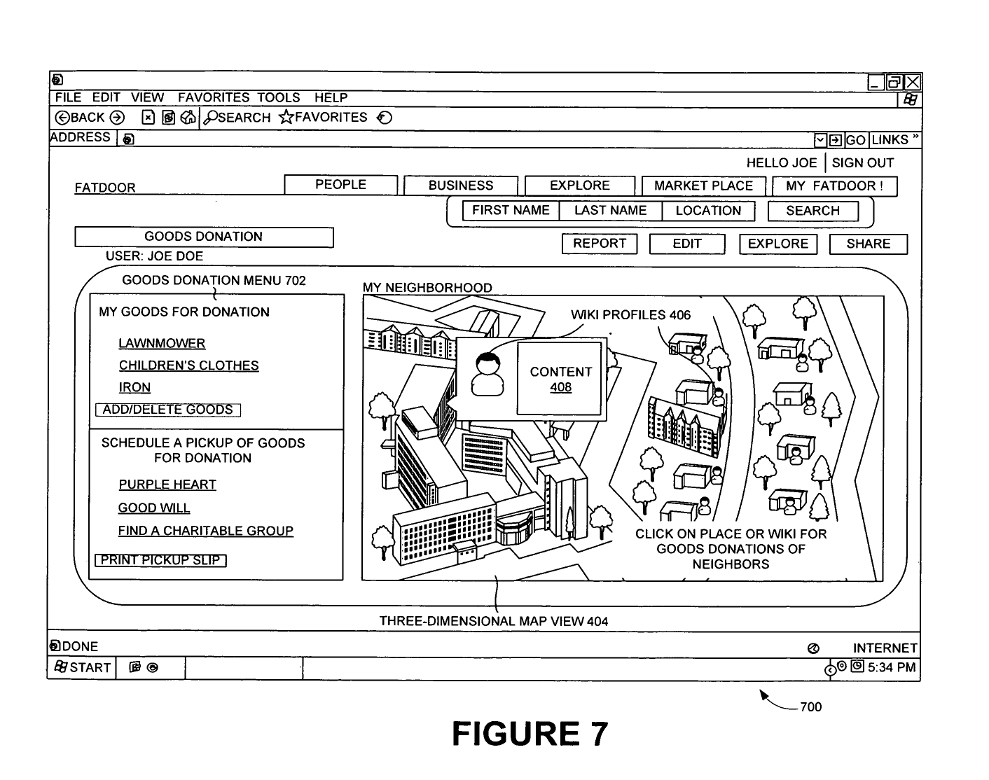

FIG. 7 is a user interface view 700 of a goods donation transaction, according to one embodiment. Particularly, FIG. 7 illustrates the three-dimensional map view 404, the wiki profiles 406, the content 408 and a goods donation menu 702, according to one embodiment.

The goods donation menu 702 may display goods and/or commodities a particular user wishes to donate to the generate the goods donation transaction in the geographic community environment 100.

In the example embodiment illustrated in FIG. 7, the users of the geographic community environment 100 may select a particular donor group, and add and/or delete goods (e.g., lawnmower, children's clothes, iron) to the donor group. The users 102 may visualize the goods donation transaction of the neighbors represented through the wiki profiles 406 in the three-dimensional map view 404. The members of the donor group may also schedule a pickup of the goods offered to the donor groups in the specific geographic location 206.

The goods donation transaction may include selecting the donor group and offering goods to the donor group. The goods donation transaction may also include scheduling the pickup of the goods offered to the donor group.

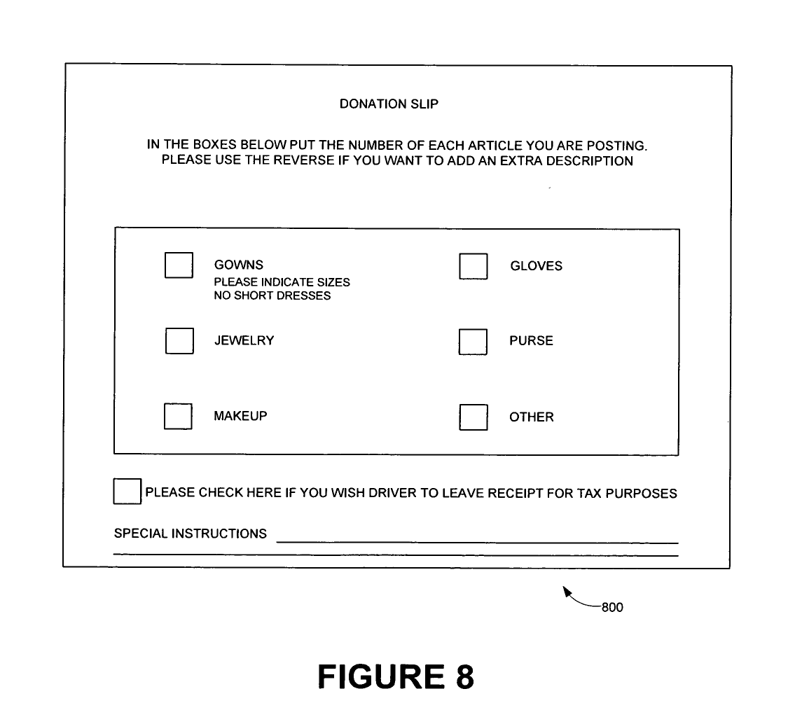

FIG. 8 is an exemplary view of a donation slip 800, according to one embodiment. Particularly, FIG. 8 shows the donation slip 800 obtained during the monetary donation transaction and/or goods donation transaction in the specific geographic location 206, according to one embodiment.

The donation slip 800 may be a receipt used for acknowledgment of the item transaction between the users 102 of the geographic community environment 100. In the example embodiment illustrated in FIG. 8, the donation slip 800 obtained during the process of item transaction in the geographic community environment 100 may contain description of different goods and/or services donated by the users 102 in the specific geographic location 206.

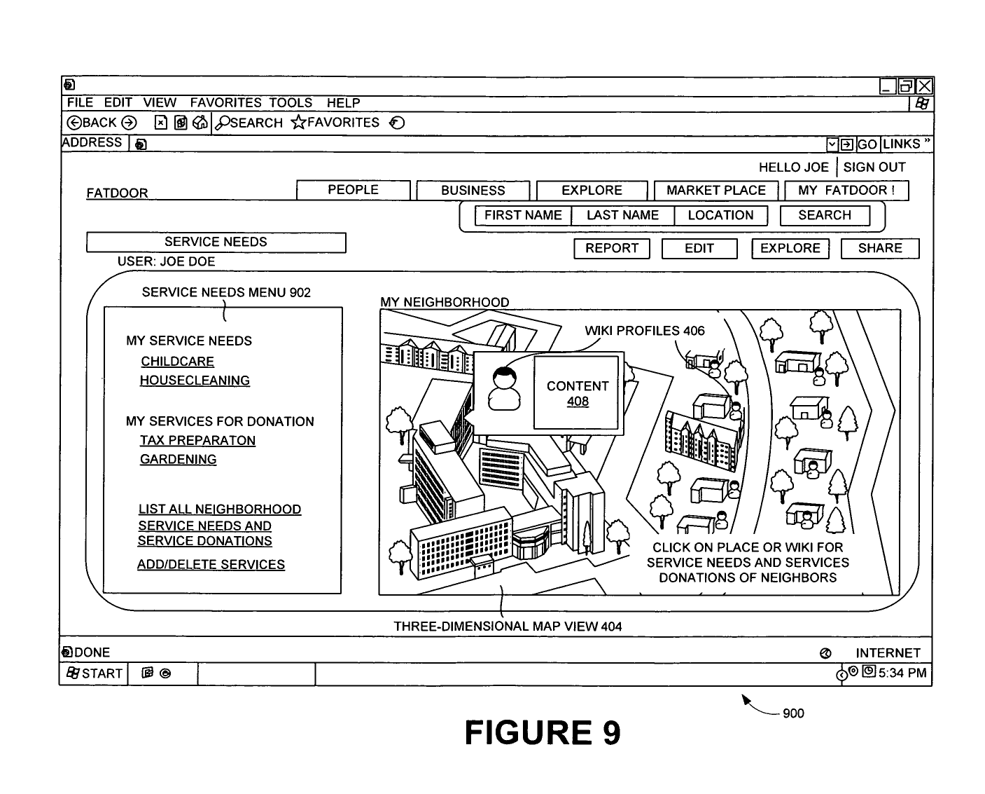

FIG. 9 is a user interface view 900 of a service needs transaction, according to one embodiment. Particularly, FIG. 9 illustrates the three-dimensional map view 404, the wiki profiles 406, the content 408 and a service needs menu 902, according to one embodiment.

The service needs menu 902 may display various services available in the neighborhood for the users 102 of the geographic community environment 100 to interact and transact with each other.

In the example embodiment illustrated in FIG. 9, the user interface view 900 displays services offered (e.g., tax preparation, gardening, etc.) and services required (childcare, house cleaning, etc.) by a particular user 102 of the geographic community environment 100. The three-dimensional map view 404 displays the wiki profiles 406 associated with various service needs in the neighborhood.

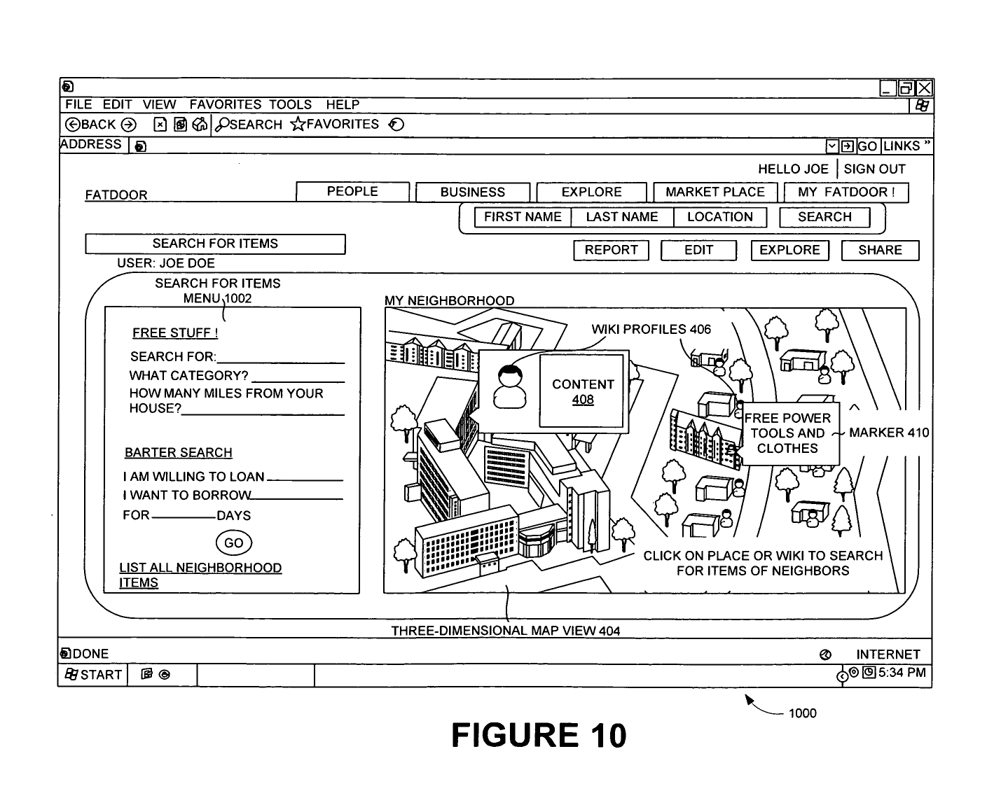

FIG. 10 is a user interface view 1000 of a search for items transaction, according to one embodiment. Particularly, FIG. 10 illustrates the three-dimensional map view 404, the wiki profiles 406, the content 408 and a search for items menu 1002, according to one embodiment.

The search for items menu 1002 may provide a list of items available for transaction (e.g., the monetary transaction, the goods donation transaction, etc.) in the neighborhood based on a location search, category search, etc.

In the example embodiment as illustrated in FIG. 10, the search for items transaction view 1000 displays the neighborhood items available for transaction. The users 102 of the geographic community environment 100 may search the items based on category, location, barter search, etc. The three-dimensional map view 404 shows different wiki profiles 406 displaying the neighborhood items.

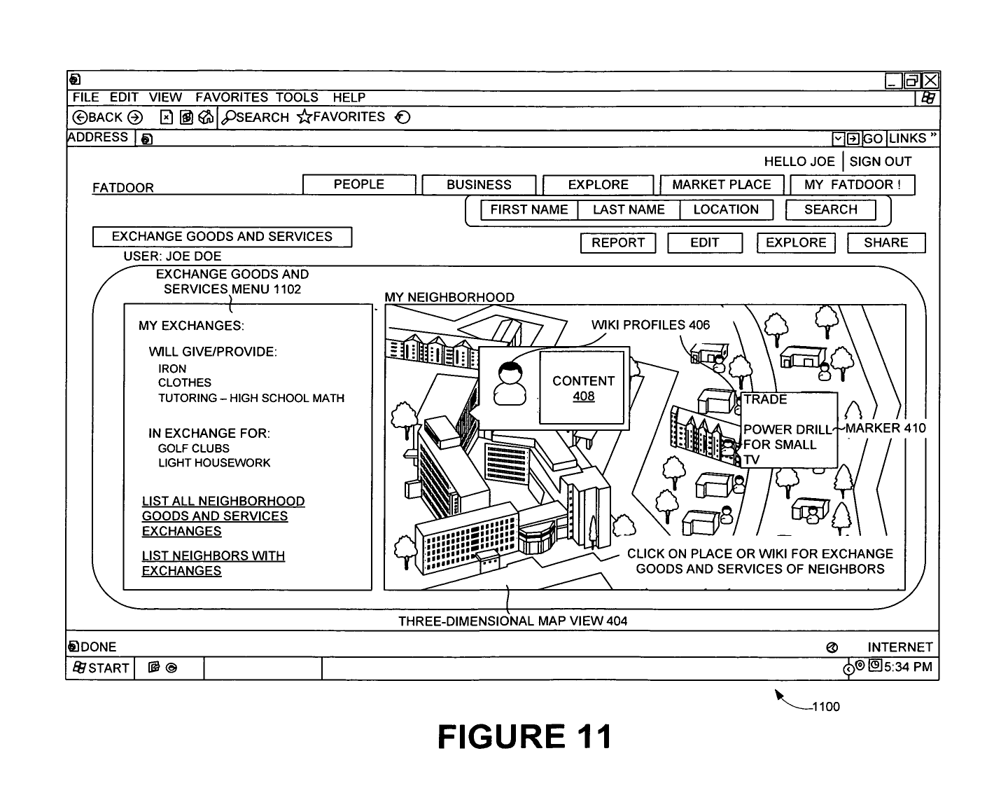

FIG. 11 is a user interface view 1100 of an exchange goods and services transaction, according to one embodiment. Particularly, FIG. 11 illustrates the three-dimensional map view 404, the wiki profiles 406, the content 408, a marker 410, and an exchange goods and services menu 1102, according to one embodiment.

The exchange goods and services menu 1102 may list the items (e.g., goods and/or services) available for exchange and may also display the neighbors interested to exchange items in the geographic community environment 100.

In the example embodiment as illustrated in FIG. 11, the exchange goods and services transaction view 1100 displays the various goods and/or services exchange activities of the neighborhood. The exchange goods and services menu 1102 shows items (e.g., iron, cloths, tutoring—high school math, etc.) available for exchange with other items (e.g., golf clubs, light housework, etc.). The three-dimensional map view 404 may also display the wiki profiles 406 and the content 408 associated with the exchange goods and services transaction.

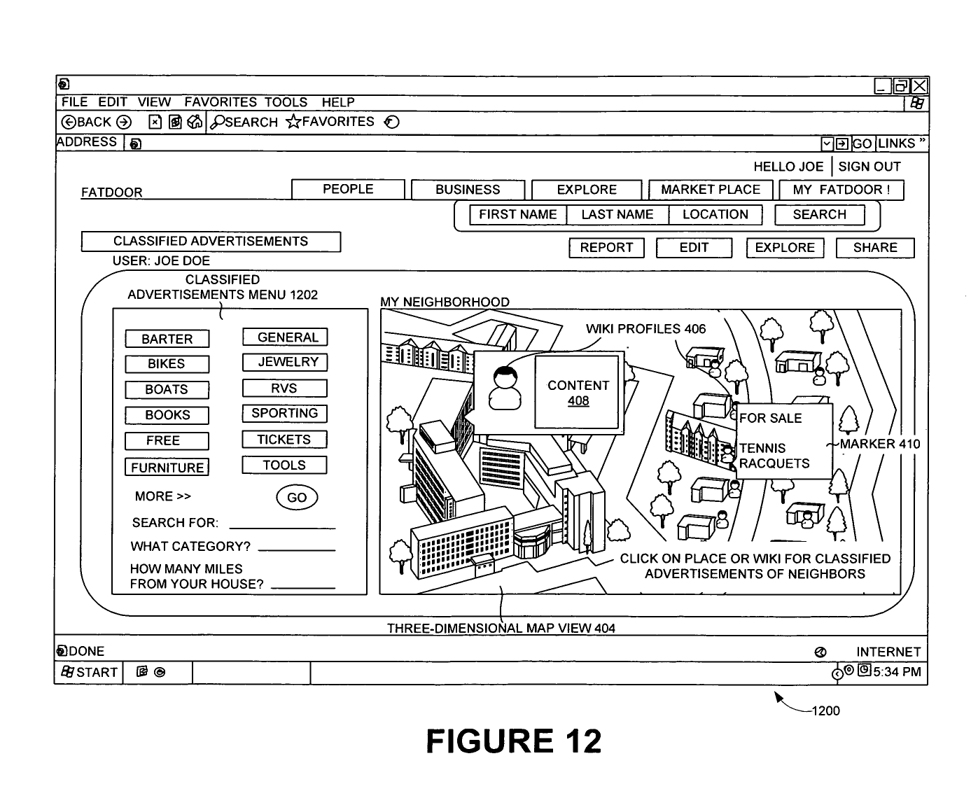

FIG. 12 is a user interface view 1200 of a classified advertisements transaction, according to one embodiment. Particularly, FIG. 12 illustrates the three-dimensional map view 404, the wiki profiles 406, the content 408 and a classified advertisements menu 1202, according to one embodiment.

The classified advertisements menu 1202 may display advertisements of goods and/or services available in the neighborhood (e.g., that are classified based on category, location, price, etc.).

In the example embodiment illustrated in FIG. 12, the user interface view 1200 displays the classified advertisements of goods and/or services (e.g., barter, bikes, furniture, jewelry, tools, etc.) available for the item transaction in the geographic community environment 100. The users 102 of the geographic community environment 100 may view the classified advertisements of neighbors through the wiki profiles 406 in the three-dimensional map view 404.

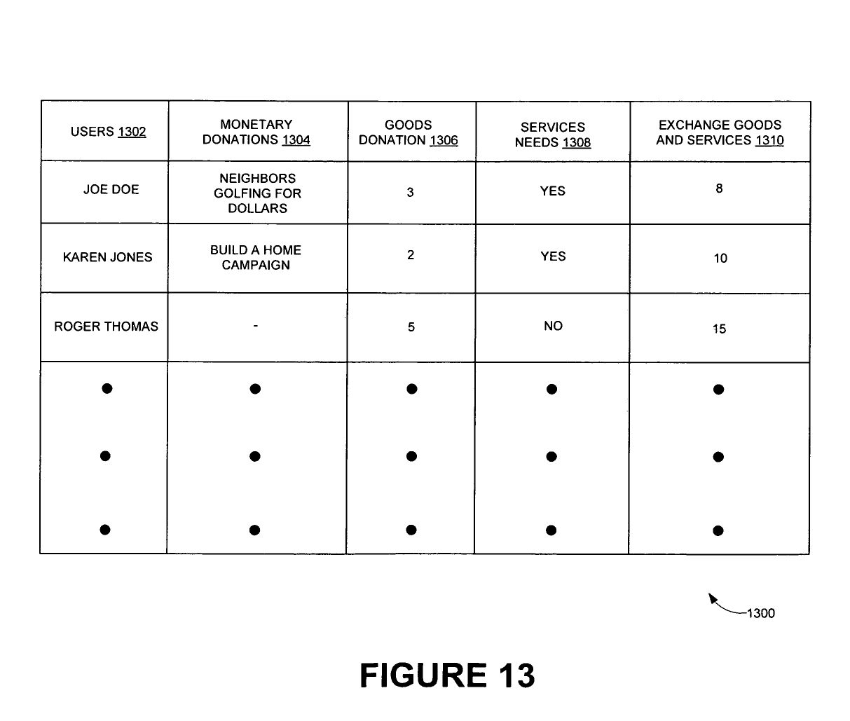

FIG. 13 is a table view 1300 displaying details of the item transaction in the geographic community environment 100, according to one embodiment. Particularly, FIG. 13 illustrates a users field 1302, a monetary donations field 1304, a goods donation field 1306, a services needs field 1308, and an exchange goods and services field 1310 according to one embodiment.

The users field 1302 may display names of the users 102 involved in the item transaction in the specific geographic location 206. The monetary donations field 1304 may show various giving groups formed in the geographic community environment 100 to perform monetary donation transactions (e.g., through the transaction module 114 of FIG. 1). The goods donation field 1306 may indicate the number of goods and/or commodities donated by the users 102 involved in the item transaction. The services needs field 1308 may indicate whether any services (e.g., a social service) are required by the users 102 of the geographic community environment 100. The exchange goods and services field 1310 may indicate the number of goods and/or services available for exchange by the users 102 during the item transaction.

In the example embodiment illustrated in FIG. 13, the users field 1302 displays “Joe Doe” in the first row, “Karen Jones” in the second row, and “Roger Thomas” in the third row of the users field column 1302. The monetary donations field 1304 displays “Neighbors Golfing for Dollars” in the first row, “Build a Home Campaign” in the second row, and “-” in the third row of the monetary donations field column 1304 (e.g., the giving group associated with Joe Doe is called Neighbors Golfing for Dollars, the giving group associated with Karen Jones is called Build a Home Campaign, and there is no giving group associated with Roger Thomas).

The goods donation field 1306 displays “3” in the first row, “2” in the second row, and “5” in the third row of the goods donation field column 1306 (e.g., Joe Doe has donated three goods, Karen Jones has donated two goods and Roger Thomas has donated five goods). The services needs field 1308 displays “Yes” in the first row, “Yes” in the second row, and “No” in the third row of the services needs field column 1308 (e.g., the users Joe Doe and Karen Jones require services, while the user Roger Thomas does not require service). The exchange goods and services field 1310 displays “8” in the first row, “10” in the second row, and “15” in the third row of the exchange goods and services field column 1310 (e.g., the goods and services available for exchange with Joe Doe is eight, with Karen Jones is ten and with Roger Thomas is fifteen).

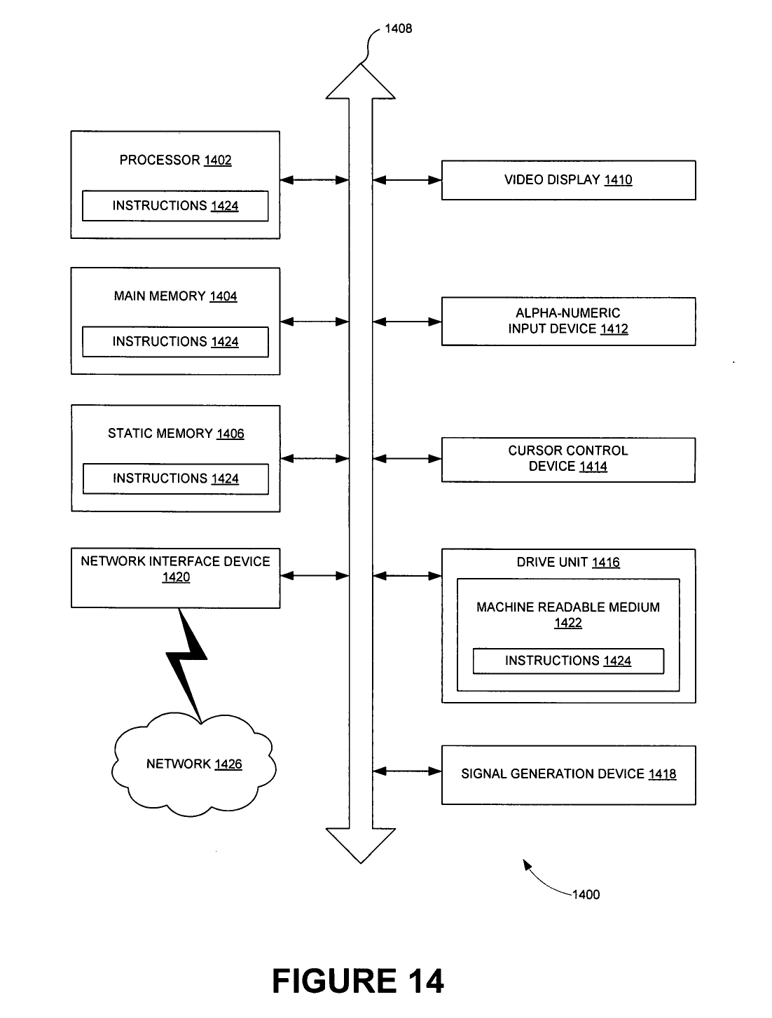

FIG. 14 is a diagrammatic system view 1400 of a data processing system in which any of the embodiments disclosed herein may be performed, according to one embodiment. Particularly, the diagrammatic system view 1400 of FIG. 14 illustrates a processor 1402, a main memory 1404, a static memory 1406, a bus 1408, a video display 1410, an alpha-numeric input device 1412, a cursor control device 1414, a drive unit 1416, a signal generation device 1418, a network interface device 1420, a machine readable medium 1422, instructions 1424, and a network 1426, according to one embodiment.

The diagrammatic system view 1400 may indicate a personal computer and the data processing system in which one or more operations disclosed herein are performed. The processor 1402 may be a microprocessor, a state machine, an application specific integrated circuit, a field programmable gate array, etc. (e.g., Intel® Pentium® processor). The main memory 1404 may be a dynamic random access memory and/or a primary memory of a computer system.

The static memory 1406 may be a hard drive, a flash drive, and/or other memory information associated with the data processing system. The bus 1408 may be an interconnection between various circuits and/or structures of the data processing system. The video display 1410 may provide graphical representation of information on the data processing system. The alpha-numeric input device 1412 may be a keypad, a keyboard and/or any other input device of text (e.g., a special device to aid the physically handicapped). The cursor control device 1414 may be a pointing device such as a mouse.

The drive unit 1416 may be the hard drive, a storage system, and/or other longer term storage subsystem. The signal generation device 1418 may be a bios and/or a functional operating system of the data processing system. The network interface device 1420 may be a device that may perform interface functions such as code conversion, protocol conversion and/or buffering required for communication to and from the network 1426. The machine readable medium 1422 may provide instructions on which any of the methods disclosed herein may be performed. The instructions 1424 may provide source code and/or data code to the processor 1402 to enable any one/or more operations disclosed herein.

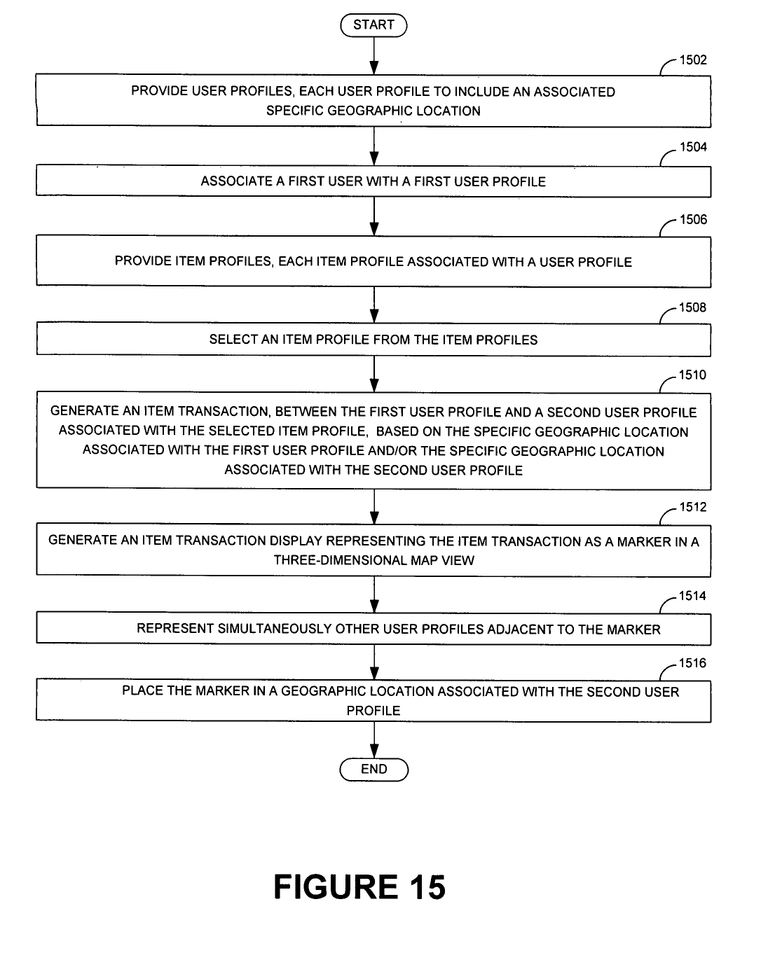

FIG. 15 is a process flow of generating an item transaction between a first user profile and a second user profile (e.g., the user profiles 204 of FIG. 2) based on a specific geographic location (e.g., the specific geographic location 206 of FIG. 2), according to one embodiment. In operation 1502, user profiles 204 may be provided (e.g., by the community network module 106 of FIG. 1), each user profile 204 to include an associated specific geographic location 206. In operation 1504, a first user 102 may be associated with a first user profile 204. In operation 1506, item profiles (e.g., the item profiles 210 of FIG. 2) may be provided (e.g., using the item module 110 of FIG. 1), each item profile 210 associated with a user profile 204.

In operation 1508, an item profile may be selected from the item profiles 210 (e.g., using the selection module 112 of FIG. 1). In operation 1510, an item transaction may be generated between the first user profile 204 and a second user profile 204 associated with the selected item profile 210 based on the specific geographic location 206 associated with the first user profile 204 and/or the specific geographic location 206 associated with the second user profile 204 (e.g., using the transaction module 114 of FIG. 1). In operation 1512, an item transaction display representing the item transaction as a marker in a three-dimensional map view (e.g., the three-dimensional map view 404 of FIG. 4) may be generated (e.g., by the display module 302 of FIG. 3). In operation 1514, other user profiles 204 may be simultaneously represented adjacent to the marker. In operation 1516, the marker may be placed in a specific geographic location (e.g., the specific geographic location 206 of FIG. 2) associated with the second user profile 204.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structures and methods may be embodied using transistors, logic gates, and electrical circuits (e.g., Application Specific Integrated Circuitry (ASIC) and/or in Digital Signal Processor (DSP) circuitry).

For example, the community network module 106, the map module 108, the item module 110, the selection module 112, the transaction module 114, the additional modules 116, the display module 302, the webpage module 304, the wiki profile module 304A, the append module 304B, the monetary donation module 306, the service needs module 308, the goods donation module 310, the search for items module 312, the exchange goods and services module 314, the classified advertisements module 314A and other modules of FIGS. 1-15 may be enabled using a community network circuit, a map circuit, a item circuit, a selection circuit, a transaction circuit, additional circuits, a display circuit, a webpage circuit, a wiki profile circuit, an append circuit, a monetary donation circuit, a service needs circuit, a goods donation circuit, a search for items circuit, a exchange goods and services circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer_system), and may be performed in any order. Accordingly, the specification and drawings are to be regarded in an illustrative rather than a restrictive sense.

What is claimed is:

1. A method, comprising:
providing a plurality of user profiles, each user profile in the plurality of user profiles to include an associated specific geographic location;
associating a first user with a first user profile in the plurality of user profiles;
providing a plurality of item profiles, each item profile of the item profiles associated with a user profile in the plurality of user profiles;
selecting an item profile from the plurality of item profiles; and
generating an item transaction, between the first user profile and a second user profile associated with the selected item profile, based on at least one of the specific geographic location associated with the first user profile and the specific geographic location associated with the second user profile.

2. The method of claim 1, further comprising:
generating an item transaction display representing the item transaction as a marker in a three-dimensional map view;
simultaneously representing other user profiles adjacent to the marker; and
placing the marker in a geographic location associated with the second user profile.

3. The method of claim 1, wherein the item transaction comprises a monetary donation transaction.

4. The method of claim 3, wherein the monetary donation transaction comprises:
forming a giving group including members, each member associated with a user profile in the plurality of user profiles; and
generating monetary donations associated with the giving group.

5. The method of claim 4, wherein the monetary donation transaction further comprises:
establishing a monetary donation campaign including a monetary donation target;
accumulating monetary donations associated with the monetary donation campaign;
calculating a total of accumulated monetary donations;
comparing the total of accumulated monetary donations to the monetary donation target; and
determining an amount of monetary donations to be collected based on the comparison of the total of accumulated monetary donations and the monetary donation target.

6. The method of claim 1, wherein the item transaction comprises a service needs transaction.

7. The method of claim 6, wherein the service needs transaction comprises:
generating a list of service needs; and
locating a service matching a service need of the list of service needs.

8. The method of claim 1, wherein the item transaction comprises a goods donation transaction.

9. The method of claim 8, wherein the goods donation transaction comprises:
selecting a donor group; and
offering goods to the donor group.

10. The method of claim 9, wherein the goods donation transaction further comprises scheduling a pickup of the goods offered to the donor group.

11. The method of claim 1, wherein the item transaction comprises a search for items transaction.

12. The method of claim 1, wherein the item transaction comprises an exchange goods and services transaction.

13. The method of claim 12, wherein the exchange goods and services transaction comprises a classified advertisements transaction.

14. The method of claim 1 in a form of a machine-readable medium embodying a set of instructions that, when executed by a machine, causes the machine to perform the method of claim 1.

15. A system, comprising:
a geographic community environment;
a community network module of the geographic community environment, the community network module to include user profiles, each user profile of the user profiles to include an associated specific geographic location;
a map module to include map data of the specific geographic location of each user profile of the user profiles;
an item module to include item profiles, each item profile of the item profiles associated with a user profile of the user profiles;
a selection module to select an item profile of the item profiles; and
a transaction module to generate an item transaction associated with the specific geographic location of the user profile associated with the selected item profile.

16. The system of claim 15, further comprising a display module to display information associated with the item transaction.

17. The system of claim 15, further comprising a webpage module to generate a webpage associated with the item transaction.

18. The system of claim 17, further comprising a wiki profile module to generate, with the webpage, at least one wiki profile associated with the webpage.

19. The system of claim 18, further comprising an append module to generate, with the at least one wiki profile, content associated with the at least one wiki profile.

20. The system of claim 15, further comprising a monetary donation module to generate a monetary donation transaction.

21. The system of claim 15, further comprising a service needs module to generate a service needs transaction.

22. The system of claim 15, further comprising a goods donation module to generate a goods donation transaction.

23. The system of claim 15, further comprising a search for items module to generate a search for items transaction.

24. The system of claim 15, further comprising an exchange goods and services module to generate an exchange goods and services transaction.

25. The system of claim 24, further comprising a classified advertisements module to generate classified advertisements.

26. A geographic community environment, comprising:
a first instruction set to enable a community network, to include a user database to include user profiles, each user profile to include an associated geographic location, and an item database to include item profiles, each item profile associated with a user profile of the user profiles, the community network associated with map data, in which the community network is associated with specific geographic locations identifiable in the map data;
a second instruction set integrated with the first instruction set to select an item profile of the item profiles; and
a third instruction set integrated with the first instruction set and the second instruction set to generate an item transaction between a first user profile of the user profiles and a second user profile associated with the selected item profile of the item profiles.

27. The geographic community environment of claim 26, further comprising:
a fourth instruction set integrated with the first instruction set and the second instruction set and the third instruction set to generate an item transaction display to represent the item transaction as a marker in a three-dimensional map view and to simultaneously represent other user profiles adjacent to the marker and to place the marker in the geographic location associated with the second user profile associated with the selected item profile.
